(19) United States
(12) Patent Application Publication
(10) Pub. No.: US 2012/0282564 A1
(43) Pub. Date: Nov. 8, 2012

(54) METHODS FOR REDUCING NOx IN SCR FOSSIL-FUEL FIRED BOILERS

(75) Inventor: Richard Marshall Himes, Dove Canyon, CA (US)

(73) Assignee: ELECTRIC POWER RESEARCH INSTITUTE, INC., Charlotte, NC (US)

(21) Appl. No.: 13/463,308

(22) Filed: May 3, 2012

Related U.S. Application Data
(60) Provisional application No. 61/481,983, filed on May 3, 2011.

(51) Int. Cl. F27D 7/00

(52) U.S. Cl. 432/19

(57) ABSTRACT

A method for reducing NOₓ in a selective catalytic reduction (SCR) fossil-fuel fired boiler includes the steps of providing a first set of optical measurement devices adapted to measure NOₓ and NH₃ concentrations contained in an exhaust stream from a fossil-fuel fired boiler, performing measurements of NOₓ and NH₃ at an SCR inlet using the first set of optical measurement devices, and determining an NH₃/NOₓ molar ratio using the measurements taken by the first set of optical measurement devices. The method further includes the steps of using the determined NH₃/NOₓ molar ratio in comparison against a user specified NH₃/NOₓ molar ratio set-point, and controlling an NH₃ control valve to match ammonia flow to changes in boiler NOₓ emissions such that the molar ratio set-point is maintained.

### BACKGROUND OF THE INVENTION

This application claims the benefit of Provisional Application No. 61/481,983 filed on May 3, 2011

The present invention relates generally to a method for reducing NOₓ in SCR fossil-fuel fired boilers.

As pollutant emissions from fossil-fuel fired boilers become of more concern, more stringent pollutant emission mandates have come into being, ultimately requiring that NOₓ emissions be reduced from a broad range of fossil-fuel fired boilers. In response, Selective Catalytic Reduction (SCR) systems have been deployed on numerous newer and larger capacity boilers. While these SCR systems have provided large overall NOₓ reductions, recent changes in boiler load profiles in response to increased use of alternative generation sources have required faster SCR controls response, as well as a more robust methodology that limits ammonia slip during transient load operation.

SCR controls approaches to date have focused on the use of inlet and/or outlet point measurements of NOₓ in the flue gas stream. Some limited applications using continuous ammonia measurements at the SCR outlet have been implemented. More particularly, current SCR controls approaches typically fall into one of the following three approaches:
1) Percent NOₓ reduction set point that is controlled on the basis of SCR inlet and outlet point measurements of flue gas NOₓ levels. Initial ammonia mass flow setting is based on the inlet NOₓ measurement converted from a volumetric to mass basis to determine the mass of ammonia required to achieve the target NOₓ reduction set point.
2) Outlet NOₓ set point with ammonia flow control based on load and/or air flow with an outlet NOₓ measurement serving as a feedback control to the ammonia flow control valve.
3) Outlet ammonia set point serving as a feedback control to the ammonia flow control valve.

Each of these approaches have inherent weaknesses. For example, these approaches incorporate extractive NO measurements which have an inherent time delay. They also require an initial estimate of the required mass flow of ammonia which entails the use of measurements to convert volume based (i.e. part per million (ppm) basis) to mass based flow rates to determine the appropriate mass of ammonia to inject, which incorporates additional measurements and/or assumptions and introduces additional inaccuracies into the computation.

Further, the first two controls approaches do not have any indication of the ammonia slip and limit the NOₓ reduction capability of the SCR system (i.e. typically <90%) in order to insure that ammonia slip levels remain below acceptable levels, generally 2 ppm, between catalyst management cycles. Finally, continuous ammonia measurements at the SCR outlet typically entail ammonia concentration measurements on the order of 1 ppm with a monitor detection limit on the order of 0.5 ppm, which stretches the detection limits of currently available continuous ammonia monitor technology using tunable diode lasers. As such, it is difficult to design a reliable control algorithm around a measurement that is near the detection limit of the monitor.

In addition, measurements of only NO at the SCR inlet does not provide information regarding the relative mixing of NH₃ relative to the NOₓ. As shown in FIG. 1, current approaches for ammonia flow control result in significant variability of the NH₃/NOₓ ratio over time as the load is ramped up or down in response to normal changes in load demand, with commensurate changes in NOₓ emissions. As the variability in the NH₃/NOₓ ratio increases, the achievable NOₓ reduction is reduced while maintaining a constant ammonia slip level, See FIG. 2. Further, as shown in FIG. 3, with current approaches, one test site exhibited about 12.8% of its operating time with SCR inlet NH₃/NOₓ ratios greater than 0.90 relative to an average NH₃/NOₓ value of 0.82. The NH₃/NOₓ ratio is greater than 0.95 for 4% of the unit operating time. Each of these SCR control approaches consequently require periodic active tuning of the SCR reagent injectors to match ammonia injection flow rates at each location with localized NOₓ levels.

Accordingly, there is a need for an SCR controls approach that provides for fast response time, continuous SCR tuning capability, and direct control to enable enhanced NOₓ reduction levels while maintaining ammonia slip levels below a target set point.

### BRIEF SUMMARY OF THE INVENTION

These and other shortcomings of the prior art are addressed by the present invention, which provides an SCR controls approach that incorporates continuous volumetric based measurements (i.e. part per million based) of NOₓ and NH₃ at the SCR inlet to enable a direct computation of the NH₃/NOₓ molar ratio downstream of the ammonia injection location. Reduced temporal and spatial variability in the NH₃/NOₓ ratio entering the SCR allows greater NOₓ reductions at the same ammonia slip, or allows the catalyst to be used for longer periods of time prior to replacement.

According to one aspect of the invention, a method for reducing NOₓ in a selective catalytic reduction (SCR) fossil-fuel fired boiler includes the steps of providing a first set of optical measurement devices adapted to measure NOₓ and NH₃ concentrations contained in an exhaust stream from a fossil-fuel fired boiler, performing measurements of NOₓ and NH₃ at an SCR inlet using the first set of optical measurement devices, and determining an NH₃/NOₓ molar ratio using the measurements taken by the first set of optical measurement devices. The method further includes the steps of using the determined NH₃/NOₓ molar ratio in comparison against a user specified NH₃/NOₓ a molar ratio set-point, and controlling an NH₃ control valve to match ammonia flow to changes in boiler NOₓ emissions such that the molar ratio set-point is maintained.

### BRIEF DESCRIPTION OF THE DRAWINGS

The subject matter that is regarded as the invention may be best understood by reference to the following description taken in conjunction with the accompanying drawing figures in which:

FIG. 1 shows NH₃/NOₓ variation over time as an SCR unit changes load using prior art methods of SCR control;

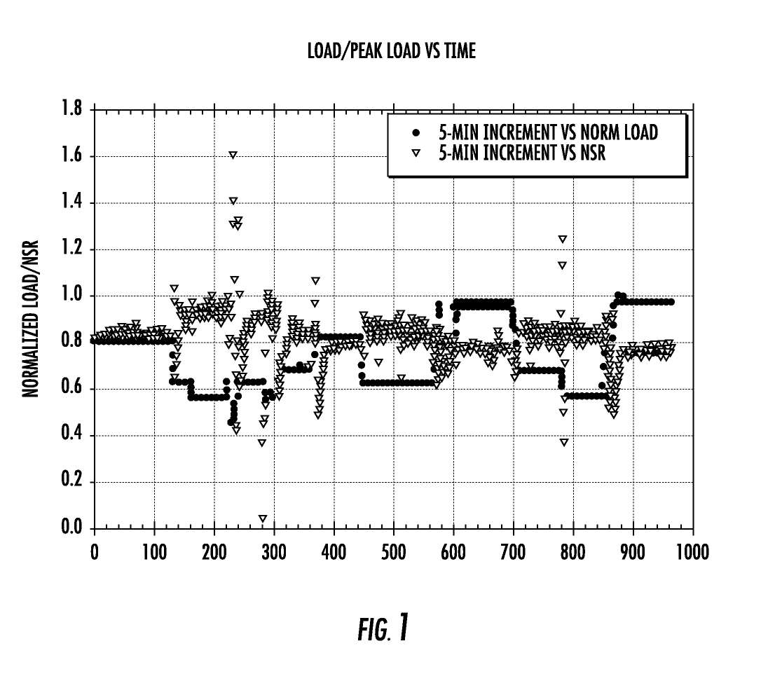

FIG. 2 shows calculated NOₓ reduction and ammonia slip performance as a function of NH₃/NOₓ ratio non-uniformity;

FIG. 3 shows temporal variability of NH₃/NOₓ of prior art SCR control methods;

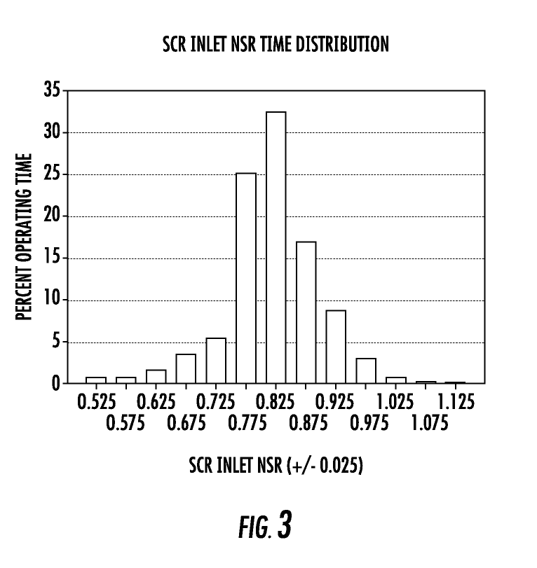

FIG. 4 is a flow diagram showing an SCR controls method according to an embodiment of the invention;

FIG. 5 shows improvements in SCR performance using the controls method of FIG. 4; and

FIG. 6 is a schematic of an SCR reactor with bluff body mixers employing the controls method of FIG. 4.

### DETAILED DESCRIPTION OF THE INVENTION

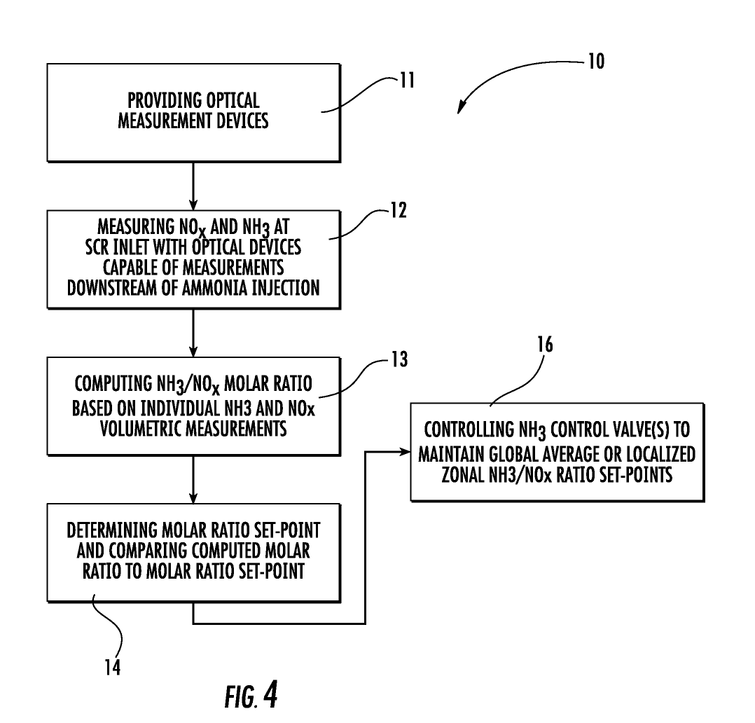

Referring now to the drawings, a method according to an embodiment of the invention is shown generally in FIG. 4 at reference numeral 10. As shown, the invention incorporates continuous volumetric based measurements (i.e. part per million based) of NOₓ and NH₃ at the SCR inlet, Block 12, using a first set of optical measurement devices, Block 11, to enable a direct computation of the NH₃/NOₓ molar ratio associated with a specific ammonia injection control valve, Block 13, downstream of the SCR catalyst using an optional second set of optical NH₃ and NOₓ measurement devices for feedback control of the ammonia injection flow rate, Block 11. Multiple measurements of the NH₃ and NOₓ concentrations allows for multiple NH₃/NOₓ molar ratio computations and enables a target set-point, Block 14, to be maintained across the SCR inlet duct cross-sectional area, thereby minimizing the variability in the NH₃/NOₓ ratio entering the SCR reactor with immediate feedback control on an NH₃ flow control valve associated with a specific flue gas measurement zone, Block 16, so as to match ammonia flow to changes in boiler NOₓ emission profiles. As shown by SCR process models, reduced variability in the NH₃/NOₓ ratio entering the SCR allows greater NOₓ reductions at the same ammonia slip, or allows the catalyst to be used for longer periods of time prior to replacement.

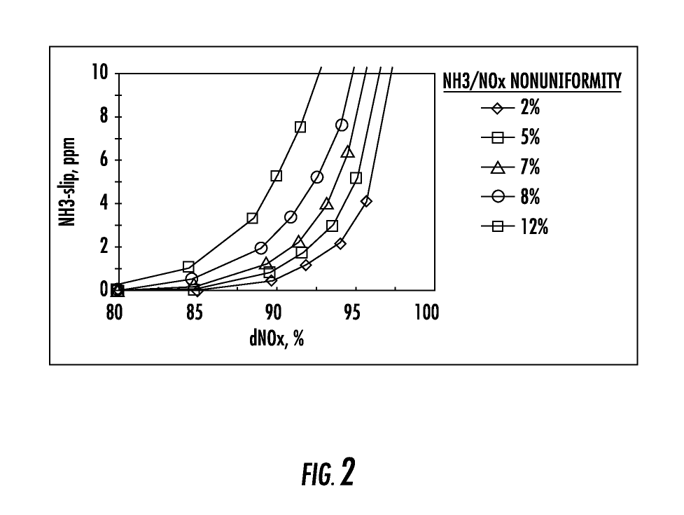

The present invention addresses inherent deficiencies in the above SCR control approaches by virtue of the following:
1) In-situ measurements of NOₓ and NH₃ at the SCR inlet, Block 12, provides the fastest response time possible to changes in boiler NOₓ emissions.
2) Multiple measurements of NOₓ and NH₃ at the SCR inlet enables potential continuous tuning capability by matching ammonia flow (feedback control of NH₃ flow control valve) to changes in localized NOₓ levels.
3) Targeting a constant NH₃/NOₓ ratio, as measured, provides direct control over the molar ratio and minimizes temporal and spatial variability. As shown in FIG. 2, systems with lower variability in the inlet NH₃/NOₓ ratio are capable of achieving greater levels of NOₓ reduction for a given level of ammonia slip.

Measurements of NOₓ can only be accomplished with existing commercial technology when made upstream of the ammonia injection grid due to interference from the ammonia. A recent demonstration has shown the viability of making in situ measurements of NOₓ using a quantum cascade laser. The controls approach can use either measurement approach, albeit greater flexibility in the measurement location is afforded with the quantum cascade laser as there is no interference from ammonia, or other flue gas constituents in the combustion generated flue gas.

Continuous measurements of ammonia can be made using near-IR or mid-IR lasers. As the ammonia concentration is higher on the inlet side of the SCR, the measurement is well above the monitor detection limits and provides signal strength on the order of 50-100 times stronger than that achievable at the SCR outlet.

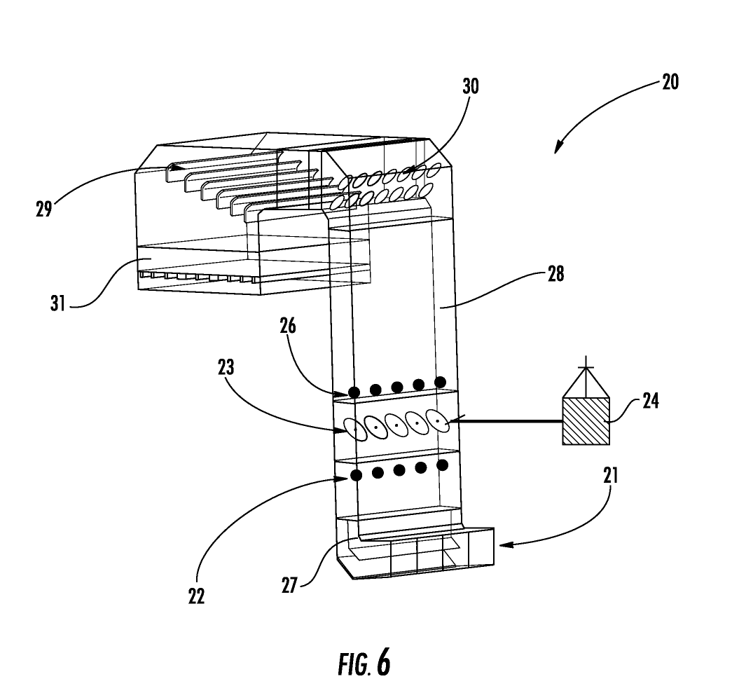

The SCR controls approach, FIG. 4, is set up by matching paired measurements of NH₃ and NOₓ with individual ammonia injectors, such as those used with a bluff body mixing approach (FIG. 6), or with groups of metered injection nozzles. For best performance, the line of sight measurement needs to correspond with the ammonia injection affecting that line of sight measurement. For bluff body mixing systems, the line of sight measurements would be located downstream of the bluff body mixer.

Referring to the bluff body mixing approach shown in FIG. 6, the SCR 20 includes an SCR inlet section 21 and ammonia injectors (such as ammonia injection inclined discs) 23 for injecting ammonia into the SCR 20. An ammonia control valve 24 is used to control the amount of ammonia injected into the SCR 20 via the injectors 23. A single control valve 24 may be used to control flow to all of the injectors 23, or multiple control valves 24 may be used to control flow to each individual injector 23. A plurality of optical measurement devices 26 for NH₃ and NOₓ are positioned downstream of the ammonia injectors 23 to measure NH₃ and NOₓ concentrations and allow an NH₃/NOₓ ratio to be computed. Additionally, a plurality of optical measurement devices 22 may be employed upstream of the ammonia injectors 23 to measure NOₓ and allow matching with NH₃ measurements taken downstream of the injectors 23. In this particular example, the SCR 20 also includes an inlet turning vane 27, a high aspect ratio duct 28, upper turning vanes 29, inclined disc mixers 30, and a first layer of catalyst 31.

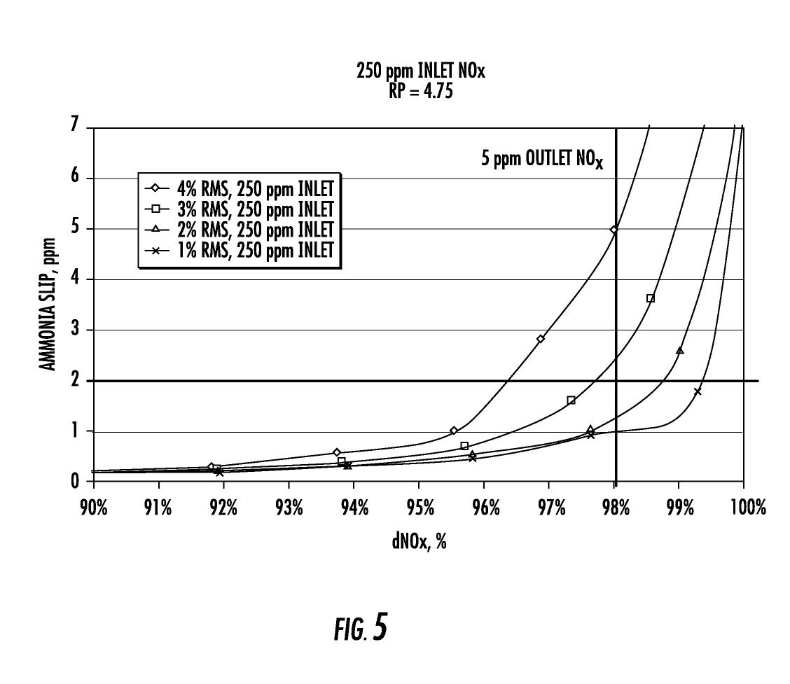

By maintaining a consistent NH₃/NOₓ ratio across the flue gas duct cross sectional area, the NH₃/NOₓ variability is minimized. This approach provides active SCR tuning capability that matches NH₃ injection to potential changes in the flue gas NOₓ distribution which can result from different mill firing patterns, fuel switching, as well as changes in air and/or fuel distribution. Having SCR inlet NH₃ data in conjunction with NOₓ enables a plant operator to reduce time variant NH₃/NOₓ, as well as providing diagnostic information regarding SCR performance. If ammonia injection controls are modified to enable zonal control, spatial variation in the NH₃/NOₓ ratio can also be addressed. As shown in FIG. 5, maintaining a more consistent NH₃/NOₓ ratio going into a SCR reactor (i.e. lower NH₃/NOₓ variability), enables greater achievable NOₓ reductions at similar ammonia slip levels and may extend the catalyst operating time before the addition of new catalyst layer is needed to maintain target NOx reduction and ammonia slip levels.

The inventive SCR controls approach is based on an NH₃/NOₓ ratio set point, which is proportional to the achievable NOₓ reduction percentage when the catalyst is new. As the catalyst ages, it deactivates at a site specific rate. Over time, the catalyst gradually ‘deactivates’ and a constant NH₃/NOₓ ratio at the SCR inlet will result in a reduced percentage NOₓ reduction and a gradual increase in the ammonia slip. In order to ensure that unacceptable ammonia slip levels do not result, outlet ammonia slip levels can be monitored using similar technology. Flue gas ammonia concentrations on the order of 4 ppm-meters provide ample signal strength for accurate measurement. This signal can be used to constrain the ammonia injection flow rate, should it be required, so as to limit the SCR outlet ammonia slip level to a specified target level.

In this manner, the ammonia slip level will be limited so as to avoid potential balance of plant impacts arising from ammonium bisulfate formation in the air heater or ammonia reaction with fly ash in the particle collection device.

The foregoing has described an SCR controls approach for fossil-fuel fired boilers. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A method for reducing NOₓ in a selective catalytic reduction (SCR) fossil-fuel fired boiler, comprising the steps of:
(a) providing a first set of optical measurement devices adapted to measure NOₓ and NH₃ concentrations contained in an exhaust stream from a fossil-fuel fired boiler;
(b) performing measurements of NOₓ and NH₃ at an SCR inlet using the first set of optical measurement devices;
(c) determining an NH₃/NOₓ molar ratio using the measurements taken by the first set of optical measurement devices;
(d) using the determined NH₃/NOₓ molar ratio in comparison against a user specified NH₃/NOₓ molar ratio set-point; and
(e) controlling an NH₃ control valve to match ammonia flow to changes in boiler NOₓ emissions such that the molar ratio set-point is maintained.

2. The method according to claim 1, wherein the measurements of NOₓ and NH₃ at the SCR inlet are volumetric based measurements.

3. The method according to claim 2, wherein the volumetric based measurements are performed on a continuous basis.

4. The method according to claim 1, further including the step of matching paired measurements of NH₃ and NOₓ with individual ammonia injectors to provide zonal control, so as to minimize spatial variation of the NH₃/NOₓ ratio.

5. The method according to claim 1, further including a second set of optical measurement devices positioned upstream of an ammonia injection point for measuring NOₓ.

6. The method according to claim 5, wherein the second set of optical measurement devices is selected from the group consisting of a quantum cascade laser for measurement of NOₓ concentrations and an in situ or extractive chemiluminescent NOₓ monitor.

7. The method according to claim 1, wherein the first set of optical measurement devices is positioned downstream of an ammonia injection point.

8. The method according to claim 1, wherein the step of determining the molar ratio set point further includes the step of performing multiple computations of the NH₃/NOₓ molar ratio using multiple measurements from the first set of optical measurement devices of NH₃ and NOₓ.

9. The method according to claim 1, wherein feedback control is used to control the NH₃ control valve.
